(19) United States
(12) Patent Application Publication
(10) Pub. No.: US 2019/0105572 A1
(43) Pub. Date: Apr. 11, 2019

(54) DRIVABLE VEHICLE AUGMENTED REALITY GAME

(71) Applicant: Actev Motors, Mountain View, CA (US)

(72) Inventors: David Bundy Bell, San Jose, CA (US); Rui Li, Santa Clara, CA (US); Clement Ching Fai Lee, Cupertino, CA (US); Alexis Josue Shimanoff, Redwood City, CA (US); Matthew Elwin Bell, San Mateo, CA (US); George Surjan, Los Gatos, CA (US)

(21) Appl. No.: 16/123,263

(22) Filed: Sep. 6, 2018

Related U.S. Application Data
(60) Provisional application No. 62/570,833, filed on Oct. 11, 2017.

(51) Int. Cl. A63F 13/803; G06T 19/00; G02B 27/01

(52) U.S. Cl. CPC A63F 13/803; G02B 27/017; G06T 19/006

(57) ABSTRACT

Drivable vehicles, such as electric go-karts, for driving in a controlled environment are equipped with a camera, a display, and a processor for controlling images on the display. In one embodiment, the camera and display are in a single smartphone, with the camera lens facing opposite to the display. The smartphone is affixed to a safety helmet, or other headgear, so that the driver can simultaneously view the display screen while seeing the real world using peripheral vision. Overlaid on the displayed real world image is any type of artificial reality image, such as obstacles, robot combatants, simulated vehicles, etc. The AR image may be independently controlled by the smartphone processor and interacts with the driver, such as by reacting to getting shot by the driver or shooting at the driver. The AR image is 3-D rendered so its perspective and size realistically changes as the vehicle is driven.

### CROSS-REFERENCE TO RELATED APPLICATIONS

This application is based on and claims priority to U.S. provisional application Ser. No. 62/570,833, filed on Oct. 11, 2017, by David Bell et al.

### FIELD OF THE INVENTION

This invention relates to independently drivable vehicles, such as go-karts, Segways™, etc., that include an augmented or artificial reality display for playing a game.

### BACKGROUND

Arcade games and amusement rides are known where the player sits on a seat and views a display of a simulated moving scene, emulating what a driver would view out of the windshield of the vehicle.

Heads-up displays are also known where an informational image is superimposed on a transparent windshield of an automobile or jet.

Aviation simulators are also known for training pilots, where a cockpit is on gimbals to simulate the actual movement of the plane. All displayed images are simulated.

Such prior art does not display any artificial reality images over a video screen image of the real world in front of the driver where an actual driver of a moving vehicle interacts with the artificial reality images. Further, such prior art does not entail interaction by a human driver with a simulated image whose movements and other actions are controlled by a computer independent from the driver's control of the vehicle. Further, such prior art does not involve driving a vehicle within a controlled environment for playing an amusement game.

What is desired is an amusement system where one or more players actually drive and independently control vehicles, such as motorized go-karts, and view a simulated image on a display while driving which changes in a way corresponding to the actual movement of the vehicles. The drivers may competitively interact with one another in a shared game environment with artificial visual effects, or a single driver may be involved in the simulated experience with artificial objects that are independently controlled.

### SUMMARY

The invention may involve any type of independently drivable vehicle, including motorized go-karts, Segways™, bicycles, scooters, etc. Electric go-karts are given as examples in the various embodiments, but the system may be installed on any other type of vehicle that can be independently controlled by the driver.

In one embodiment, electric go-karts are provided with a display conveying both an image needed for the driver to negotiate around a track or open area in conjunction with overlaid augmented reality images.

In one embodiment, electric go-karts are provided with a display, such as above the steering wheel, so that the driver may view the displayed image as well as the real world around the driver.

In another embodiment, the driver only looks at the display while driving since the display conveys the actual track image or a simulated image of the track or other scenery. The track may actually be an open area.

In another embodiment, the driver's helmet is augmented with a front display that displays animated images over a camera image of the real world scene in front of the driver as the driver drives the go-kart. As the driver turns his/her head, the scene moves since the camera is attached to the helmet. The display is spaced away from the driver's head and the driver can see the real world through the driver's peripheral vision. Allowing the driver to view the real world through peripheral vision while simultaneously viewing the display in front of the driver avoids stress and better orients the driver.

The helmet supporting the display, or other type of headgear supporting the display, may be used independently of the go-kart. The ability to simultaneously view the display in front of the wearer and view the real world through the wearer's peripheral vision improves the wearer's experience over immersive displays or over simply holding the display when the wearer is walking or is in some other dynamic environment. For uses where safety is not an issue, the headgear may provide no head protection.

In another embodiment, the display is immersive, meaning that the driver's vision is limited to the display, and the image moves as the driver's head moves to emulate a simulated environment.

In one embodiment, a front camera captures the real world in front of the go-kart and displays the image on a screen in front of the driver while an image processor overlays animations regarding the game as augmented or artificial reality. The front camera may be in a conventional smartphone or tablet that also displays the composite image to the driver and processes all information for the system. WiFi, cellular, wires, GPS, or Bluetooth may be used to feed back go-kart data to the smartphone or tablet.

In the various embodiments, movement of simulated scenery in the display generally corresponds to the actual movement of the go-kart (or other type of vehicle).

In one embodiment, a number of actual drivers interact in a common game involving displayed simulated scenery. All drivers see different views of the same overall scenery, depending on the drivers' positions.

Simulated weapons may be available to the drivers, and the drivers may press buttons on the steering wheel to shoot the weapons at other go-karts. The effects of the weapons are then simulated on the displays. Each driver sees a unique display customized for that driver since the displayed image generally corresponds to what is actually ahead of the driver. Tactile feedback (haptics) may be used when shooting a weapon or when the driver gets hit by a simulated combatant. The simulated combatants are independently controlled by a computer to interact with the driver in unpredictable ways, adding to the excitement of the game.

The display may show the various other go-karts and scenery as different shapes, such as tanks, race cars, space ships, etc.

In one embodiment, only a single driver participates in the simulated experience. Other vehicles may be simulated on the display. For example, the display may show a simulated city environment and the driver negotiates turns, stops, etc. while actually driving the go-kart.

In another embodiment, multiple actual drivers participate in a shared game.

Succeeding at the game being played involves the drivers' actual driving skills as well as other skills in playing the displayed game.

Safety features are employed to ensure there are no collisions, since on-board processors can override the driver controls and control braking, steering, etc. The system may override the driver controls as a penalty in the game.

Sounds may also be simulated.

In one embodiment, a group of go-karts have transceivers that communicate with a shared computer, or a local processor on the go-kart, or one or a number of cloud-based processors on the go-kart or remote from the go-kart. All the drivers have a display, whether mounted on the go-kart or within the driver's helmets. As the drivers drive around a track, the display may show any scenery passing that roughly corresponds to the go-kart's movements. Thus, physical forces related to acceleration and turning are actually experienced rather than simulated.

In one embodiment, each go-kart uses a programmed smartphone or tablet processor for the image processing, detection of steering etc., and display. WiFi, cellular, wires, or Bluetooth may be used for communications.

A portable central controller/transceiver may be provided to effectively set up a controlled driving area in any location, such as a large parking lot. The go-karts can then participate in any of the available games.

The system provides a customizable platform for any type of augmented or artificial reality environment. The user may program the system to play any type of game involving the actual driving of any type of vehicle, including go-karts.

The term “artificial reality” is used herein to connote a non-real world image that reacts to movement of the driver/vehicle so as to change its appearance (e.g., size, angles, etc.) in a generally realistic way. The term “augmented reality” is used herein to connote a live direct view (through a transparent screen) or an indirect view (a camera display) of a physical, real-world environment whose elements are “augmented” (overlaid) by computer-generated images.

Other embodiments are described.

### BRIEF DESCRIPTION OF THE DRAWINGS

FIG. 1 illustrates an actual electric go-kart augmented with a front display showing augmented or artificial reality images generally corresponding to the actual movement of the go-kart. The displayed game may involve a plurality of identical go-karts which are driven independently and play a shared game, or the displayed game may involve only a single driver.

FIG. 2 illustrates a go-kart where the driver wears a helmet supporting a display and camera in front of the helmet and an opening allowing the driver to see the real world through the driver's peripheral vision.

FIG. 3 is a front view of a smartphone mounted in front of the helmet, where the front camera captures the real world view in front of the driver and the smartphone display is augmented with artificial objects that move corresponding to the movement of the go-kart.

FIG. 4 is a side view of the helmet supporting the camera and display. Bottom and side openings for peripheral vision are shown.

FIG. 5 is an example of a screen image displayed to the driver, showing a camera-captured image of the actual driving area, a gun sight, a combatant robot, and a laser shot by the driver's weapon.

FIG. 6 illustrates certain functional units for a go-kart in the augmented/artificial reality system.

FIG. 7 is a flowchart showing steps performed during a driver game using the system.

Elements that are the same or equivalent are labelled with the same numerals.

### DETAILED DESCRIPTION

The invention may involve any type of independently drivable vehicle, including motorized go-karts, Segways™, bicycles, scooters, etc. Electric go-karts are given as examples in the various embodiments, but the system may be installed on any other type of vehicle that can be independently controlled by the driver. The driving may occur around a shaped track, or in an open area, or in a simulated shaped track in an open area.

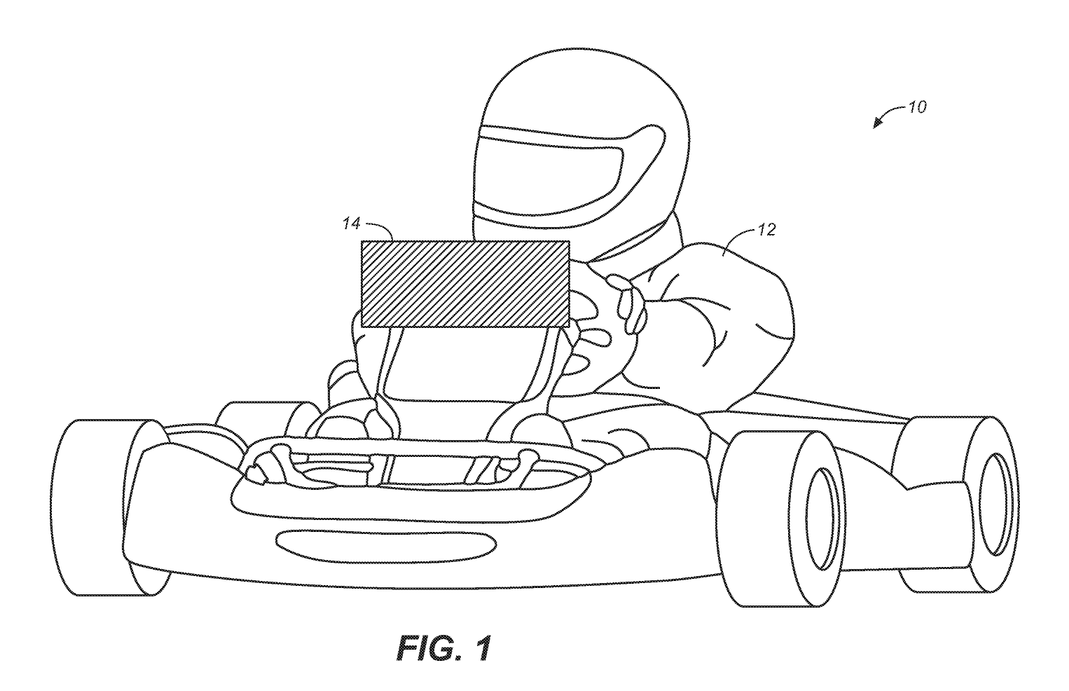

FIG. 1 illustrates an electric go-kart 10. The go-kart 10 includes a battery, an electric motor, a coupling for turning the wheels, a steerage system for steering the front wheels, an accelerator, and a brake. Although the driver 12 directly controls the speed and direction of the go-kart 10, the controls may be overridden for safety or to represent a penalty, as described later.

An augmented/artificial reality system is included in the go-kart 10 and, in some cases, also external to the go-kart 10. The augmented/artificial system, in one embodiment, includes a high resolution color display screen 14 facing the driver 12 so that the driver 12 can see the display screen 12 while driving yet still focusing on the track ahead. The display screen 14 may be a tablet screen, a smartphone screen, or other display screen.

In one embodiment, while the driver 12 is driving the go-kart 10 around the track, with or without other drivers, the image displayed on the screen 14 is moving in a way corresponding to the movement of the go-kart 10, basically emulating what the driver 12 would view out of the vehicle.

In one embodiment, the screen 14 displays a totally animated moving scene that replaces the actual scene around the driver 12. For example, the scene may be an outdoor road in a famous location or outer space. The scene moves in accordance with the direction and speed of the go-kart 10 so that the driver 12 experiences actual g-forces while being in a simulated video environment.

The displayed scene may include simulated vehicles, whose positions are purely simulated, or the displayed vehicles may correspond to the positions of other actual go-karts on the same track. All players view a customized scene on their screens since their physical positions on the track are different.

In one embodiment, only a single driver can be on the track since the simulated video environment is a simulated outdoor environment involving obstacles, traffic lights, and other effects that may involve erratic driving. The track may have any shape and may just be a large open area.

The go-kart 10 may have control buttons on the steering wheel that aim and fire simulated weapons. The weapon burst is then simulated on the screen 14 and its effects on the scenery or other vehicles are also simulated, such as an explosion.

The augmented/artificial reality system may add simulated obstacles in the path that the driver 12 must avoid. If the driver 12 hits the obstacle, the system may briefly apply the brake or rattle the go-cart 10. In one embodiment, the driver actually drives in an open area, but simulate track boundaries are overlaid on the open area image and the driver must negotiate the simulated track boundaries. Penalties are assessed when the driver goes outside the simulate boundaries, such as the go-kart braking and steering being taken over by the system. The visual simulations are up to the software designer, and the hardware platform described herein may be used for a wide variety of themed games that involve the actual driving of the go-karts 10.

When multiple go-karts 10 are on the same track playing an interactive game, a central processor, or local processor, or cloud-based processor(s) may transmit data to all the different display screens 14. Each driver is shown a different image customized for that driver's location on the track. Actions by one driver, such a firing a weapon at another go-kart, affect the other driver's screen image or tactile feedback, such as simulating the go-kart getting hit by a weapon projectile. The driver's local processors may directly communicate with one another, or communications may be via a remote central processor. The drivers compete against each other by, for example, simulating shooting each other with weapons. A driver's go-kart may be simulated to be disabled after a hit for a short period of time where the motor control is overridden by the central processor. After the game, the winning driver is identified.

In another embodiment, instead of the display 14 displaying a totally simulated environment, a front camera, such as a camera in a smartphone display, displays the camera-captured image of the moving real world in front of the go-kart 10 (or in the direction the driver's head is facing). Artificial reality images are generated and combined (overlaid) with the real world images. The artificial reality images are rendered so that their perspective and size change in a realistic way as the go-kart 10 moves.

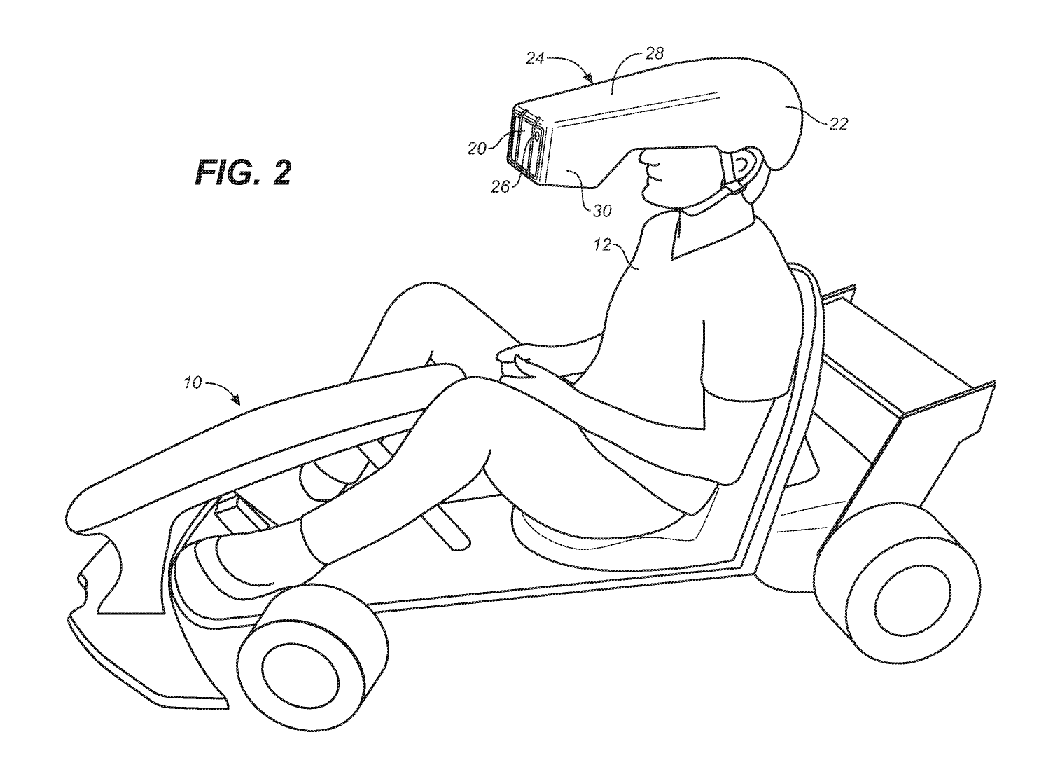

FIG. 2 illustrates another embodiment of a display 20 mounted on a helmet 22. The display 20 may be a smartphone that is releasably attached to the front of the support structure 24. The smartphone has a front camera with a lens 26. The support structure 24 is attached to the safety helmet 22 and spaces the display 20 about 25 cm from the driver's eyes to allow the driver to easily focus on the display 20. The helmet 22 and support structure 24 may be integrated into a single headgear piece.

The support structure 24 has a top portion 28 and side portions 30 to shade the display 20 from ambient light for better viewing. The side portions 30 and bottom are open sufficiently to allow the driver 12 to see the real world through the driver's peripheral vision so the driver 12 simultaneously sees the display 20 and the real world. Experiments by the inventors have shown that the driver 12 has an unsettling experience while driving if the driver 12 cannot see peripherally. Enabling the driver 12 to view the real world through the driver's peripheral vision helps the driver 12 orient and feel safer. An immersive video experience while actually driving may be too disorienting for an enjoyable experience, but is still contemplated by the inventors. A direct retinal projection may be used instead of the driver viewing the display screen.

The camera and display do not need to be attached to a helmet but should be supported in a way that moves along with the driver's head. Any type of headgear may support the camera and display.

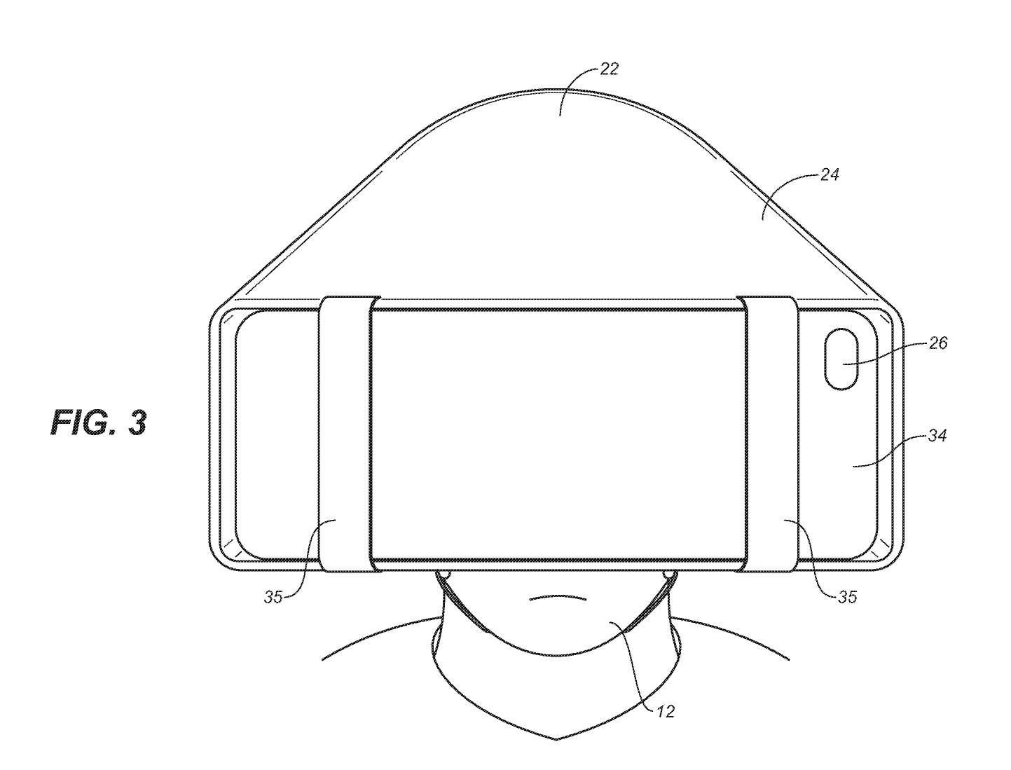

FIG. 3 is a front view of the support structure 24 supporting a smartphone 34, which has a high definition display on its opposite side and a camera lens 26 on its front side. The camera feature is active, and the real world captured by the wide angle camera lens 26 is displayed to the driver 12. The video image may also be recorded by the smartphone 34. The smartphone 34 is held in place in the structure 24 using straps 35 or any other type of retaining device.

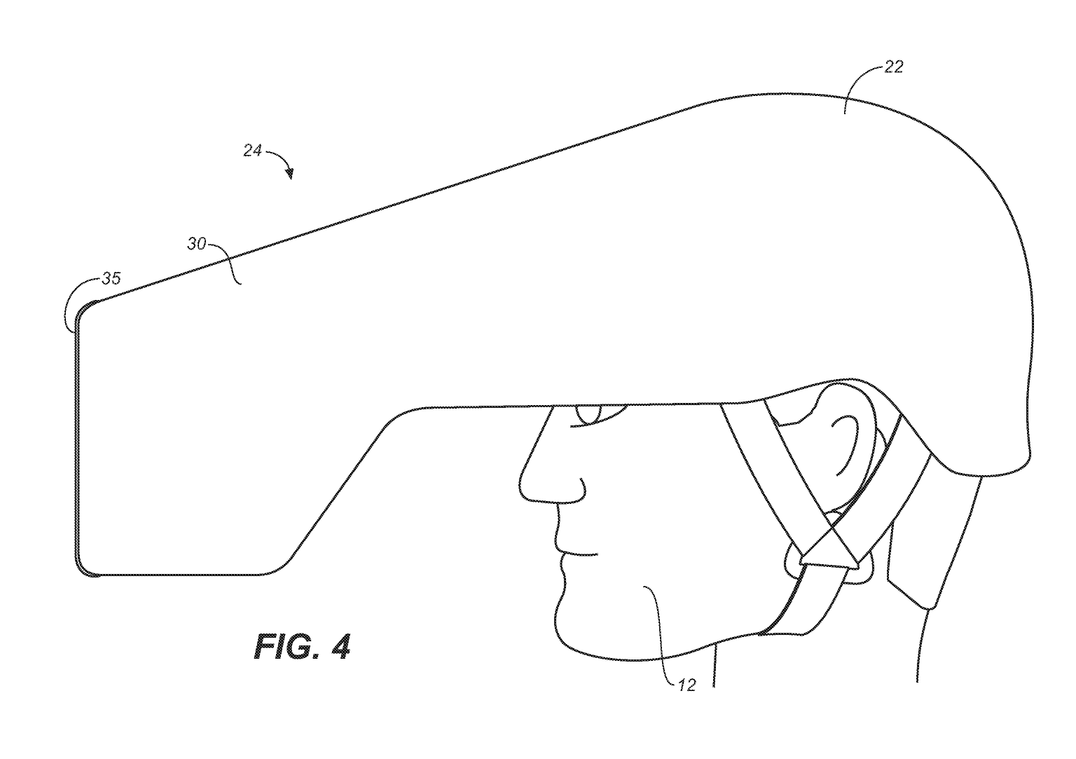

FIG. 4 is a side view of the helmet 22 and support structure 24, showing the openings in the side portions 30 and bottom to allow the driver 12 to partially see forward and to the side using peripheral vision. The obstructed angle in front of the driver 12 may be in the range of plus and minus 45 degrees from normal.

The display and camera arrangement of FIG. 4 may instead be mounted on another type of head-supported structure for use with a safer driving experience, such as using a Segway. A safety helmet may not be required. In another example, the wearer can be walking. The ability to see the augmented reality display while also peripherally seeing the real world is important for safety and enables the wearer to better orient.

In one embodiment, the driver may simply wear glasses or goggles with a display/camera attachment, such as Google Glass™.

In another embodiment, the display is within the driver's helmet or goggles. This may provide an immersive environment. In one embodiment, the generated images are projected or otherwise overlaid on the helmet's visor so the driver 12 sees the real world through the visor while also seeing the augmented/artificial reality images superimposed over the real world. In one embodiment, the images presented to the driver 12 in the immersive environment change based on the driver's head movement. The head movement may be detected using accelerometers or other known feedback mechanisms.

Many other applications of the artificial/augmented hardware platform are envisioned.

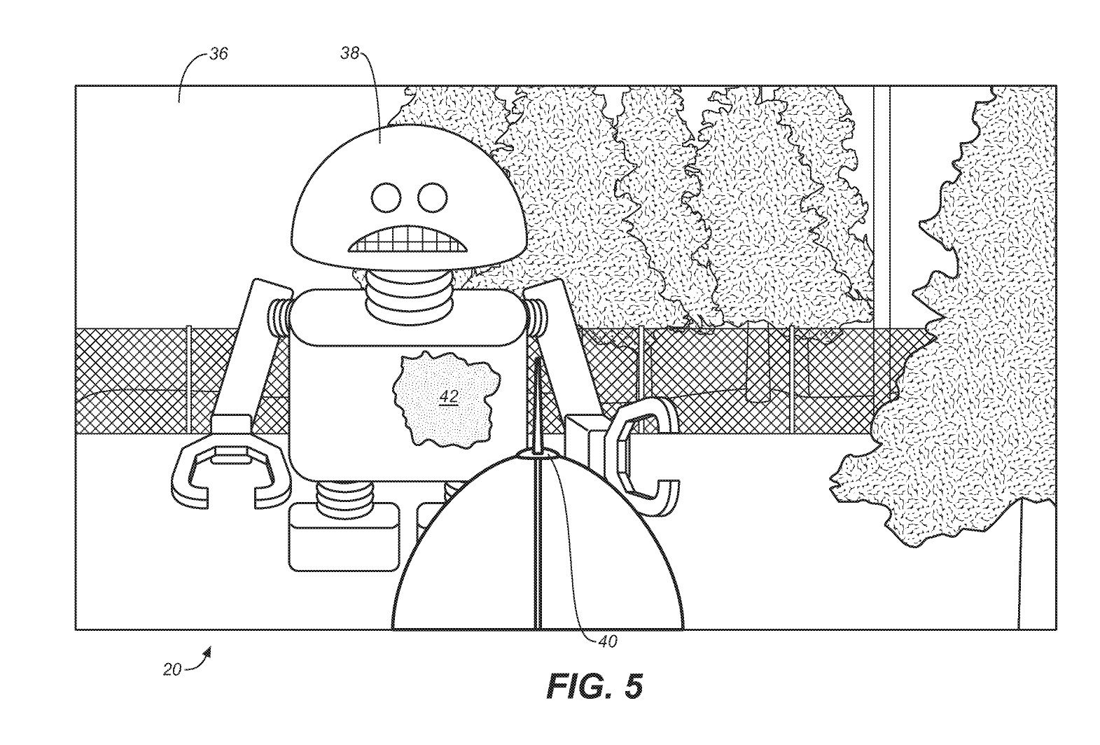

FIG. 5 is a sample screen shot from the display 20 during a particular game. The real world scenery 36 is captured by the camera in the smartphone, and a combatant robot 38 is computer-generated and overlaid on the real world image. A simulated gunsight image 40 is also generated, and the driver operates switches on the steering wheel to shoot laser bursts 42 at the robot 38. In this case, the position of the driver's head (controlling the camera view) may position the gunsight image 40. In another embodiment, the driver may change the position of the gunsight image 40 independent of head movement.

The image of the robot 38 moves in a realistic way as the go-kart 10 is driven. Points may be accumulated by a hit or the robot 38 may be killed after a certain number of hits or after a well-aimed hit. The robot 38 is also controlled to shoot back, and this may be sensed by the go-kart's smartphone computer to provide physical feedback to the driver, such as a vibration or brief application of the brakes. Transducers may vibrate the driver's seat upon a simulated hit of the go-kart. Small electric shocks via the steering wheel may also provide feedback to the driver when the driver is hit.

The robot 38, or other computer generated image, is controlled independently by the computer. So there is two-way interaction between the driver and the computer generated image. If the driver's go-kart runs into the robot 38, there may be feedback, such as application of the brakes.

In another embodiment, another person can control the robot 38.

In another embodiment, simulated barriers are overlaid on the display of the real world and, if the driver hits a simulated barrier, the computer applies the brakes and takes any other appropriate action.

Any scenario may be programmed. The artificial/augmented reality images that can be generated are limitless.

The system uses any of a number of ways to track the movement of the go-kart and use such feedback to control the simulated image (artificial reality) being displayed. In one embodiment, GPS, lasers, accelerometers, sonar, and other known instruments are used. The smartphone may apply GPS, but the accuracy may be augmented by lasers, sonar, and accelerometers.

The display, camera, vehicle control, and feedback may use any combination of communication techniques, such as WiFi, cellular, wires, IR, or Bluetooth.

The track may be any open space or a dedicated oval or serpentine track. For a single-driver game, all the processing is contained on the go-kart (or other type of vehicle). For a multi-driver game, a portable central transceiver/processor, or a cloud-based system, for detecting the signals from the various go-karts can be used to keep track of the shared game and coordinate the various displays, if appropriate.

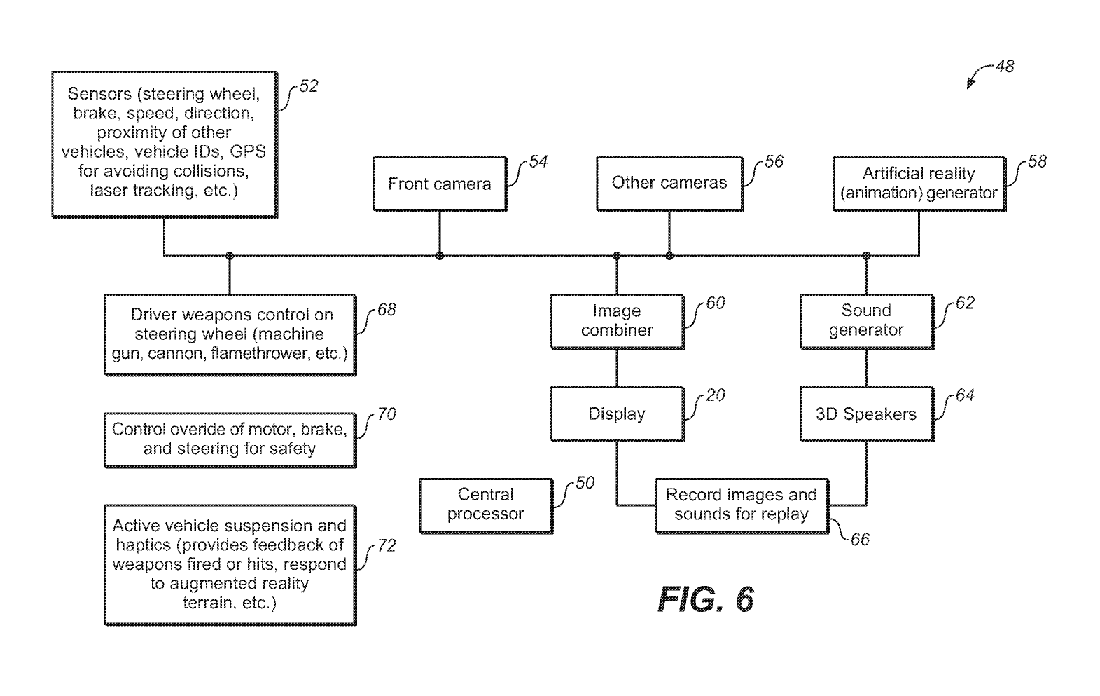

FIG. 6 shows various functional units in one embodiment of the augmented/artificial reality system 48. If multiple go-karts are involved in a shared game, a central processor 50 controls the system 48 and may be remote from the go-karts 10 and communicate with the go-karts 10 via RF or IR signals. For example, the RF communications may be by WiFi, cellular, or Bluetooth. A conventional programmed computer or cloud-based system may be the central processor 50. In some applications, such as for a single go-kart game, there is no need for a central processor, and all processing is done by a computer on the go-kart, such as a tablet or smartphone.

The processor 50 (whether central or in the go-kart) requires feedback from the go-kart(s) 10 in order to control the simulated images on the display 20 to move generally proportional to the actual movement of the go-kart 10 so g-forces are realistic. If a shared game is played, the central processor 50 may control only shared aspects of the game. The central processor 50 and/or the local processors perform the function of an image controller for the displays 20. Sensors 52 are built into the go-kart 10 to measure steering, braking, speed, direction (e.g., using GPS, accelerometers, etc.), proximity to other vehicles, vehicle ID signals, laser tracking signals, video camera signals, etc.

In one embodiment, the displayed image is only partly simulated, with the scenery being an actual image of what is in front of the go-kart 10. In such a case, the go-kart 10 is equipped with a front camera 54. Other cameras 56 may give different views to the driver 12, such as a rear view, so the driver 12 can see other vehicles approaching.

In one embodiment, a high resolution animation is overlaid over the actual real world scene in front of the go-kart 10. Such an overlay may be an obstacle, a robot, vehicles, or any other image. An augmented/artificial reality generator 58 generates any simulated image that is displayed. The simulated image may include vehicles that do not exist in reality and any simulated scenery.

The real images captured by the cameras 54 and 56 are combined with the simulated images by an image combiner 60, using conventional video techniques.

In another embodiment, the entire image displayed is simulated, yet moves consistent with the actual movement of the go-kart.

Artificial sounds may also be created by a sound generator 62, and the sounds may be output by speakers 64 in the driver's seat and in front of the driver 12 for a 3-dimensional effect. Transducers may also be in the driver's seat to simulate bumps or crashes.

The displayed images and sounds for a particular concluded race may be recorded for later playback by a recorder 66.

Weapons controls 68, such as buttons, may be on the steering wheel and may include a machine gun, a laser cannon, a flamethrower, etc. The firing of such weapons is fed back to the processor 50, and simulated images of the firing and results are shown on the display 20.

A control override module 70 allows the processor 50 to control the go-kart 10 to override the motor control, brake, and steering for safety or for feedback during the game. Transducers are used for such override.

The feedback system may also provide sensory feedback to the driver 12 by controlling the suspension 72 to simulate bumps in the road, getting hit by another player's weapon, etc. The feedback also includes haptics in the steering wheel to be used for various purposes, including gaming (laser firing, hit by a projectile, etc.) and safety warnings, such as getting too close to an obstacle or other vehicle. A steering servo allows the computer to take control over steering, in addition to acceleration and braking, to avoid obstacles and other vehicles whether actual or simulated.

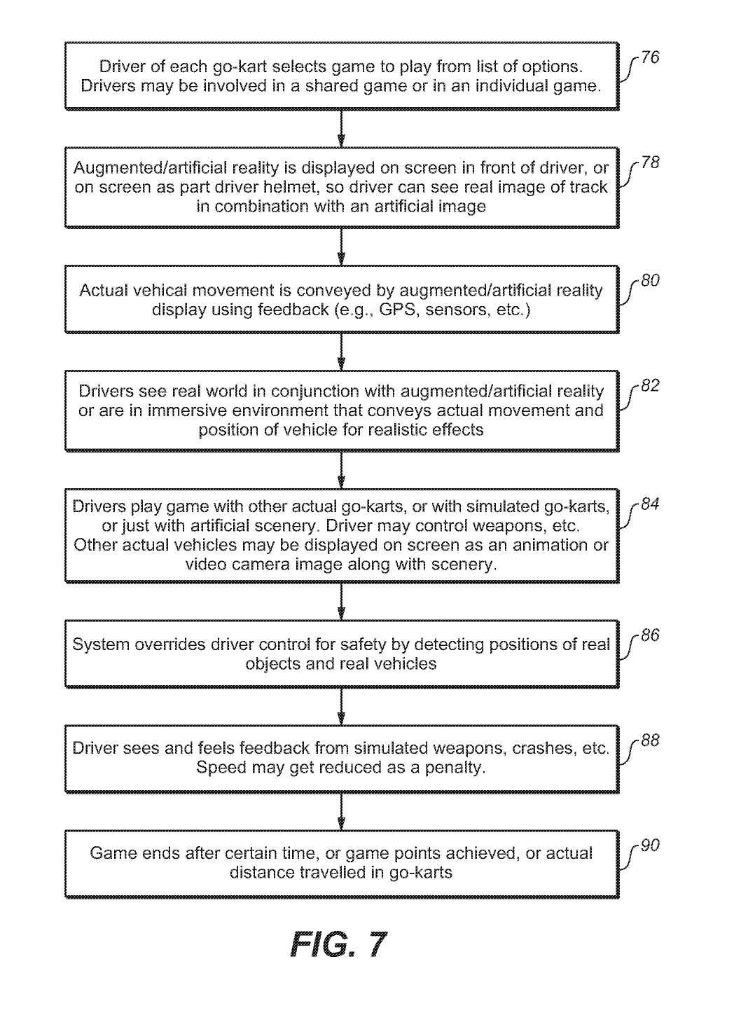

FIG. 7 identifies various steps that may be performed in a game played between drivers independently controlling moving go-karts 10.

In step 76, the driver of each go-kart selects a game to play. Multiple drivers may be on the same track or open area and select different games or a shared game.

In step 78, the augmented reality image is displayed to the driver such that the driver sees a dynamic real world image along with a dynamic simulated image overlaid on top of the real world image.

In step 80, as the driver drives the go-kart, feedback signals cause the simulated image to move in a realistic manner as the real world image naturally moves due to the camera attached to the front of the headgear.

In step 82, the driver views the display screen and is generally immersed in a dynamic artificial/augmented reality experience while independently driving the go-kart and experiencing the physically effects of driving.

In step 84, the driver plays the game, such as shooting weapons at the simulated images and, optionally, competing with other drivers in a shared game. The simulated images may include other go-karts, monsters, obstacles, strange environments, etc. In one game, the drivers simulate shooting each other.

In step 86, the go-kart systems, such as steering and braking, may be overridden for safety, such as if the driver is going to crash into another driver or a real obstacle.

In step 88, the driver sees and feels feedback from firing simulated weapons or getting hit with a simulated weapon. Transducers may be in the seat and steering wheel that register a hit by an external weapon. A penalty may include the go-kart's maximum speed being limited for a period of time. All the drivers' computers (e.g., smartphones, tablets, etc.) may be linked together using a common computer, or one of the smartphones may be the shared computer.

In step 90, the game ends and a winner is declared. Alternatively, there is no competition between players. Any type of game may be played.

A particular type of vehicle location tracking system is described below. Such a system is more accurate than using GPS.

In a go-kart driving environment, it is often useful to have real time information on the positions of one or more vehicles. This may be useful for gaming purposes (e.g., scoring), displaying augmented reality images, or for preventing collisions.

Safety is of utmost importance when children are driving go-karts, and it becomes more challenging when the drivers may be distracted by augmented reality (AR) images. The system described below may be used to warn the driver when a collision with a fixed object or another go-kart is imminent. It may also be possible for a central computer to take control of the go-kart to prevent a collision without any driver intervention.

The system should be able to track the positions, velocities and orientations of multiple vehicles within a limited driving area (e.g., a parking lot or indoor driving center). This system should also be able to store the locations of physical obstacles such as curbs and light poles.

In one embodiment, a vehicle tracking system includes the following features:
Multiple go-karts with drivers.
Each go-kart has two short posts (inserted into the flag pole holders on either side of the go-kart seat back) with ˜1″ diameter clear plastic balls on the top of each post. These plastic balls will be located roughly 6″ either side of the driver's head, and slightly above the top of the driver's head.
At the base of each clear plastic ball is a high intensity LED (most likely blue). Each LED is connected to the go-kart's controller so it may be turned on and off by the controller.
Each go-kart is connected via WiFi to a central control computer that has the ability to take control of each go-kart (acceleration, brakes and possibly steering).
At least two video cameras are positioned above the drivers. These cameras should have a view of the entire driving area, and ideally be aimed orthogonally to each other. (More than two cameras may be necessary for large driving areas). The camera could be mounted on the ceiling of an indoor driving area, or on tripods with tall poles in an outdoor driving area.
The video cameras are connected to the central computer via cable or wireless protocol (e.g., WiFi).
Prior to driving in the designated area, a person with a handheld device (also containing one or two LED lit balls) walks the perimeter of the driving area so the central computer can identify the perimeter via the connected video cameras. Similarly, the locations of all obstacles are identified and recorded by the central computer. Alternatively, a go-kart could be driven instead of a handheld device to identify the perimeter and obstacles. The fixed spacing of the balls permits the central computer to accurately determine the dimensions of the driving area and exact locations of obstacles.
During driving, the LEDs on each go-kart are lit by the go-kart controllers.
Each go-kart has an independent WiFi connection (and identifying number) with the central computer. In addition, all of the LED-lit balls on all go-karts are visible through the video cameras.
The central computer can identify the position of each go-kart by sequentially sending a WiFi command to the go-kart to briefly turn off the LEDs (for a fraction of a second). The video cameras can see the LEDs flash, and thereby identify the exact location of each go-kart.
The left and right LEDs on each go-kart are individually controllable by WiFi commands from the central computer, so the computer can uniquely identify both left and right balls.
By pinging each go-kart during driving, the central computer can verify the identity of each go-kart, and track them during driving. Because the spacing of the plastic balls on each go-kart is fixed, and both left and right balls are individually identified, it is possible for the central computer to track the location, velocity (the combination of speed and direction) and orientation of each go-kart in real time.
It is important to be able to track both velocity and orientation separately because the velocity and orientation vectors are not always aligned (e.g., during drifting).
With position, velocity, and orientation information for each go-kart, plus previously stored locations of all obstacles, it is possible for the central computer to predict imminent collisions and take mitigating actions.
Additional information available in each go-kart may be uploaded to the central computer. Information such as accelerator pedal position, brake pedal position, 3-axis acceleration, 3-axis gyro, wheel speed, and steering angle may be useful to the collision avoidance algorithm.
Commands may be sent to one or more go-karts via WiFi to take control over the acceleration, braking, and even steering (when a steering servo is installed). The driver(s) can also be alerted by sound through the speakers or haptics in a Smart Steering Wheel when collision avoidance actions are taken.
It is further possible for the vision system and the central computer to identify any other objects entering the driving area and prevent collisions. These could include other vehicles such as cars, bicycles, or running children.

The system and methods disclosed can be easily adapted to any other independently controllable vehicle, such as Segways™, bicycles, scooters, etc.

Accordingly, an augmented/artificial reality system that operates in conjunction with actual moving go-karts is described, where the actual movement of the go-karts is totally controlled by the driver and is translated into a corresponding movement of the image on a display screen for each driver. The augmented/artificial reality game played thus involves actual driving skills as well as skills in playing the game.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. An amusement system comprising:
a first drivable vehicle whose speed and direction are controlled by a driver supported by the vehicle;
a display screen viewable by the driver;
a camera mounted on a support structure so that the camera captures real world moving images as the driver drives the vehicle, and the display screen displays such real world moving images;
a controller coupled to process feedback signals from the vehicle at least pertaining to the speed and direction of the vehicle; and
the controller being configured to control the display screen to display simulated images that change in accordance with the actual movements of the vehicle, wherein the simulated images on the screen emulate a view from the vehicle.

2. The system of claim 1 further comprising one or more control actuators operable by the driver to create an artificial visual effect on the display screen.

3. The system of claim 1 wherein the controller is configured to control actions of the simulate images independent of any driver control.

4. The system of claim 3 wherein actions of the simulated images comprise actions that cause the controller to control one or more transducers in the vehicle.

5. The system of claim 4 wherein the actions of the simulated images comprise actions that cause the controller to control a physical movement of the driver.

6. The system of claim 5 wherein the physical movement of the driver comprises braking of the vehicle controlled by the controller.

7. The system of claim 5 wherein the actions of the simulated images comprise actions that cause a vibration of the driver.

8. The system of claim 1 further comprising headgear worn by the driver, the headgear supporting the display screen a distance away from the driver's face.

9. The system of claim 8 wherein the headgear allows the driver to see the real world through the driver's peripheral vision while also viewing the display screen.

10. The system of claim 8 wherein the display screen and camera are contained in a smartphone releasably affixed to the headgear.

11. The system of claim 1 wherein the camera and display are coupled to headgear worn by the driver.

12. The system of claim 1 further comprising:
additional drivable vehicles, whose speed and direction are controlled by associated drivers sitting in the additional vehicles;
each of the additional drivable vehicles including a display screen viewable by an associated one of the drivers of the vehicles, the display screens being configured to display simulated images that change positions within the screens in accordance with the actual movements of the vehicles, wherein images on the screens emulate a view out from the vehicles; and
one or more control actuators operable by each driver to create an artificial visual effect on the display screen for that driver during the playing of a game shared by the drivers, wherein operating the one or more control actuators by a first driver in the shared game affects a second driver in the shared game.

13. The system of claim 1 wherein the vehicle is an electric go-kart.

14. The system of claim 1 wherein the vehicle is a Segway.

15. The system of claim 1 wherein the vehicle comprises a motor.

16. The system of claim 1 further comprising transducers that provide physical feedback to the driver.

17. An amusement system comprising:
a first drivable vehicle whose speed and direction are controlled by a driver supported by the vehicle;
a display screen viewable by the driver;
headgear worn by the driver, the headgear supporting the display screen a distance away from the driver's face, the headgear providing a top covering for shading the display screen from the sun, the headgear having a bottom opening and side openings for allowing the driver to see the real world through the driver's peripheral vision while also viewing the display screen; and
a controller coupled to process feedback signals from the vehicle at least pertaining to the speed and direction of the vehicle,
the controller configured to control the display screen to display simulated images that change in accordance with the actual movements of the vehicle, wherein the simulated images on the display screen emulate a view from the vehicle.

18. The system of claim 17 further comprising a camera mounted on the headgear so that the camera captures real world moving images as the driver drives the vehicle, and the display screen displays such real world moving images.

19. The system of claim 17 further comprising one or more control actuators operable by the driver to create an artificial visual effect on the display screen.

20. The system of claim 1 wherein the controller is configured to control actions of the simulate images independent of any driver control.
